(19) United States
(12) Patent Application Publication
(10) Pub. No.: US 2008/0069572 A1
(43) Pub. Date: Mar. 20, 2008

(54) Optical transmission device

(75) Inventors: Hiroto Ikeda, Kawasaki (JP); Toshihiro Ohtani, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/892,301

(22) Filed: Aug. 21, 2007

(30) Foreign Application Priority Data
Sep. 19, 2006 (JP) 2006-252470

(51) Int. Cl. H04B 10/00

(52) U.S. Cl. 398/158

(57) ABSTRACT

Occurrence of a reception error and breakdown of a device are prevented by absorbing an optical surge that occurs at the time of an instantaneous interruption of light. Dummy light having a wavelength at which a Raman gain is obtained when the wavelength of a main signal is assumed to be the wavelength of the pump light of a Raman amplifier is combined in a combiner with the main signal, and the combined light is introduced into an optical fiber where, by exploiting the SRS effect, the energy of the optical surge occurring in the main signal is absorbed into the dummy light, thus absorbing the optical surge.

### BACKGROUND OF THE INVENTION

1. Field of the Invention

The present invention relates to an optical transmission device which suppresses an optical surge that occurs in an optical transmission system due to an instantaneous interruption of light, etc.

2. Description of the Related Art

Generally, optical transmission systems that use optical fibers as transmission lines use optical amplifiers to achieve long-distance transmissions.

FIG. 1 shows an example of the basic configuration of an optical transmission system that uses optical amplifiers. At an end station 10 (transmitting end), signal lights of different wavelengths from a plurality of transmitters 12 are combined with an optical combiner 14, and the resulting wavelength multiplexed signal is amplified by an optical amplifier 16 and transmitted on an optical transmission line formed from an optical fiber 18. Repeater amplifiers 20 are provided at prescribed intervals along the optical transmission line. At an end station 22 (receiving end), the wavelength multiplexed signal from the optical transmission line is amplified by an optical amplifier 24 and separated by an optical splitter 26 into signal lights of different wavelengths, which are respectively supplied to a plurality of receivers 28.

To satisfy the required transmission quality, it is desirable to hold the input power to the transmission line, which corresponds to the output of the optical amplifier 16, and the input power to the receivers 28 to within a given specified range. For this purpose, the optical transmitter 10 or the optical receiver 22 may be equipped with a VOA (Variable Optical Attenuator) as an optical power level adjuster to adjust the optical power level to an optimum level, and thereby control the optical power at a constant level.

In such an optical transmission system, if the transition time of an optical power variation is several to several tens of milliseconds or longer, the optical power can be maintained at an appropriate level by the control using the VOA or by an optical amplifier equipped with a high-speed ALC (Auto Level Control) function. However, in the optical transmission system, a sudden change in optical power can occur due to problems or failures such as an instantaneous interruption of light at the time of path switching.

For example, in the optical transmission system of FIG. 1, if a sudden change in optical power occurs as shown in FIG. 2 by reference numeral 30 due to a failure such as an instantaneous interruption of light at the time of path switching, an optical surge will occur momentarily in the optical amplifier. If such a momentary optical surge occurs in the optical amplifier 16 at the end station 10 or in the optical amplifier 20 within a repeater, an excessive amount of optical power will be transmitted downstream as shown by reference numeral 32. In particular, if the system is constructed by connecting optical amplifiers in multiple stages, the effect of the optical surge will accumulate from one optical amplifier to the next, and the resulting excessive power will be input to the receiver 28 at the downstream end, as shown by reference numeral 34. In this case, since the input power to the light detector or other optical component in the receiver 28 cannot be limited to within an acceptable level, an error will occur in the receiver 28, and in the worst case, the light detector or other components may break down.

When an optical surge occurs, constant optical power control being performed by the VOA in the optical transmitter 10 or optical receiver 22, which has a time constant of several to several tens of milliseconds including the response time of the VOA and the controller for controlling the VOA, cannot respond quickly to the optical surge whose transition time is on the order of microseconds, and as a result, the input power to the light detector in the optical receiver 22 cannot be properly limited, causing an error at the receiver 28, and in the worst case, leading to a breakdown of the light detector or other components.

When an optical surge occurs, even an optical amplifier equipped with a high-speed ALC (Auto Level Control) function cannot respond quickly as it takes some milliseconds to control the pump light of the optical amplifier.

Likewise, if the output power set value of the optical amplifier is erroneously set to a high power level, the reception level at the receiving end may momentarily rise, leading to breakdown of optical components, optical receivers, measuring instruments, etc.

### SUMMARY OF THE INVENTION

It is an object of the present invention to reduce a momentary excessive power increase, such as an optical surge in an optical amplifier or the like, and thereby prevent a reception error or breakdown of a light detector from occurring at the downstream end.

According to the present invention, there is provided an optical transmission device comprising: an optical transmission medium into which signal light of a first wavelength is introduced as a main signal, the optical transmission medium having a function to amplify signal light of a second wavelength when the signal light of the first wavelength is introduced therein; and a combiner for combining the main signal with dummy light of the second wavelength, and thereby introducing the dummy light into the optical transmission medium, wherein an optical surge occurring in the main signal is reduced by providing gain to the dummy light.

For example, the optical transmission medium includes an optical fiber, and amplification is an amplification occurring due to stimulated Raman scattering in the optical fiber.

### BRIEF DESCRIPTION OF THE DRAWINGS

FIG. 1 is a diagram showing an example of an optical transmission system that uses optical amplifiers;

FIG. 2 is a diagram for explaining how an optical surge occurs and how it affects the system;

FIG. 3 is a graph showing a Raman scattering spectrum;

FIG. 4 is a diagram showing a Raman amplifier system which exploits SRS for optical amplification;

FIG. 5 is a diagram for explaining an SRS effect;

FIG. 6 is an example in which an optical transmission device according to the present invention is provided in a transmitting end station;

FIG. 7 is an example in which the optical transmission device according to the present invention is provided in a repeater;

FIG. 8 is an example in which the optical transmission device according to the present invention is provided in a receiving end station;

FIG. 9 is a diagram showing simulation results of the SRS gain for the case of a normal input;

FIG. 10-1 is a diagram showing simulation results of the SRS gain when an optical surge occurred;

FIG. 10-2 is a diagram showing simulation results of the SRS gain when an optical surge occurred;

FIG. 10-3 is a diagram showing simulation results of the SRS gain when an optical surge occurred;

FIG. 10-4 is a diagram showing simulation results of the SRS gain when an optical surge occurred;

FIG. 11 is a diagram showing a configuration that uses two dummy light sources of different wavelengths;

FIG. 12-1 is a diagram showing simulation results for the configuration of FIG. 11;

FIG. 12-2 is a diagram showing simulation results for the configuration of FIG. 11;

FIG. 12-3 is a diagram showing simulation results for the configuration of FIG. 11;

FIG. 13 is a diagram showing simulation results when fiber length was extended;

FIG. 14 is a diagram showing the configuration of a fiber module according to one embodiment of the present invention;

FIG. 15-1 is a diagram showing simulation results when Aeff was chosen to be 30 μm² and when the power of dummy light was increased;

FIG. 15-2 is a diagram showing simulation results when Aeff was chosen to be 30 μm² and when the power of dummy light was increased; and

FIG. 15-3 is a diagram showing simulation results when Aeff was chosen to be 30 μm² and when the power of dummy light was increased.

### DESCRIPTION OF THE PREFERRED EMBODIMENTS

An optical transmission device according to the present invention reduces an optical surge by exploiting, for example, SRS (Stimulated Raman Scattering).

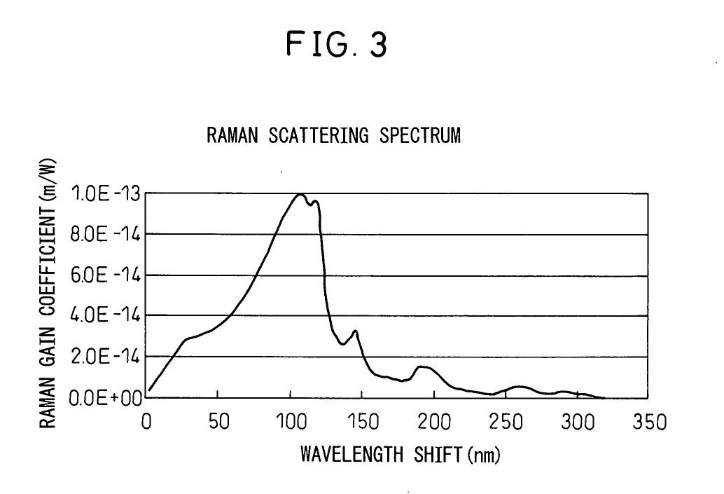

SRS is one of nonlinear effects occurring in optical fibers; with this effect, the power of the pump light decreases, and the optimum amplification wavelength region resides in a wavelength range shifted from the pump wavelength toward longer wavelengths by about 100 nm to 120 nm, thus providing gain to the longer wavelength region. FIG. 3 shows a Raman scattering spectrum.

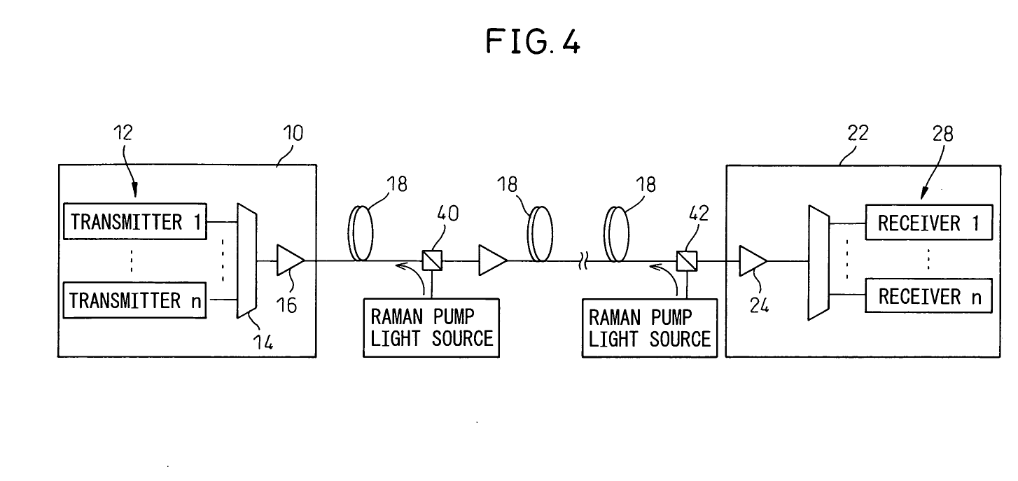

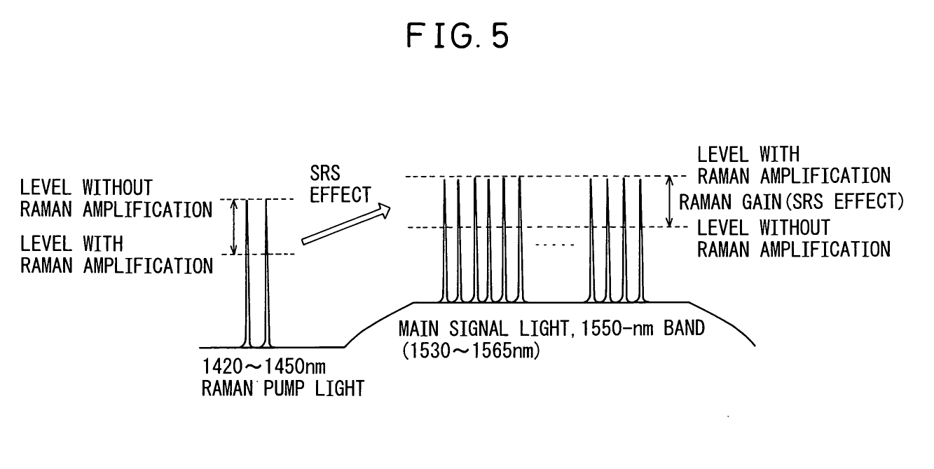

FIG. 4 shows one example of a Raman amplifier system which exploits SRS for optical amplification. At combiners 40 and 42 provided at intermediate points along the optical transmission line, the pump light is combined with the main signal and introduced into the optical fiber 18. As shown in FIG. 5, the power of the pump light decreases, but scattered light occurs in the region shifted toward longer wavelengths, thus achieving gain.

In the present invention, in order to reduce the optical surge by exploiting SRS, a dummy light source is used that emits light in the wavelength region (for example, 1650-nm to 1680-nm region) shifted from the main signal region (for example, 1550-nm region) toward longer wavelengths by about 100 nm to 120 nm (corresponding to about 13 THz in terms of frequency). Further, a highly non-linear fiber (HNLF) having an effective cross-sectional area (Aeff) of 50 μm² or less, preferably about 10 μm², and having a high nonlinear effect generation efficiency, is used as the medium for generating SRS. By using an optical fiber with reduced Aeff and increased optical power concentration, and thereby enhancing the nonlinear effect generation efficiency, fiber length can be reduced, which serves to reduce the size of the device, as well as the loss of optical power.

By exploiting SRS occurring in the optical fiber, an excessive power increase that momentarily occurs in the main signal band in the event of an optical surge can be reduced by providing gain to the light source in the longer wavelength region.

In the present invention, the main signal corresponds to the pump light in the Raman amplifier, and the dummy light corresponds to the signal light in the Raman amplifier.

The SRS gain is expressed by the following equation.

$$Gain ( dB ) ≅ \frac{g r \cdot P \cdot L eff}{2 A eff} 10 log e$$

gr: Raman gain coefficient (m/W)

Aeff: Effective cross-sectional area (μm²)

Leff: Effective fiber length (km)

P: Pump light power (mW)

From the above equation, doubling of the pump light power in terms of mW leads to a Raman gain increase of two times in terms of dB.

In the above configuration, when the main signal is combined with the longer wavelength dummy light and introduced into the optical fiber, an SRS effect occurs between the generated optical surge and the dummy light, and the optical surge can be reduced by providing gain to the dummy light. This serves to prevent excessive power exceeding the rated power from being input to the optical receiver.

SRS is a nonlinear effect, and the transition time required for the SRS effect to become apparent is nearly zero. Accordingly, by utilizing this physical phenomenon, any instantaneous optical surge occurring in the main signal can be reduced without involving any time constant.

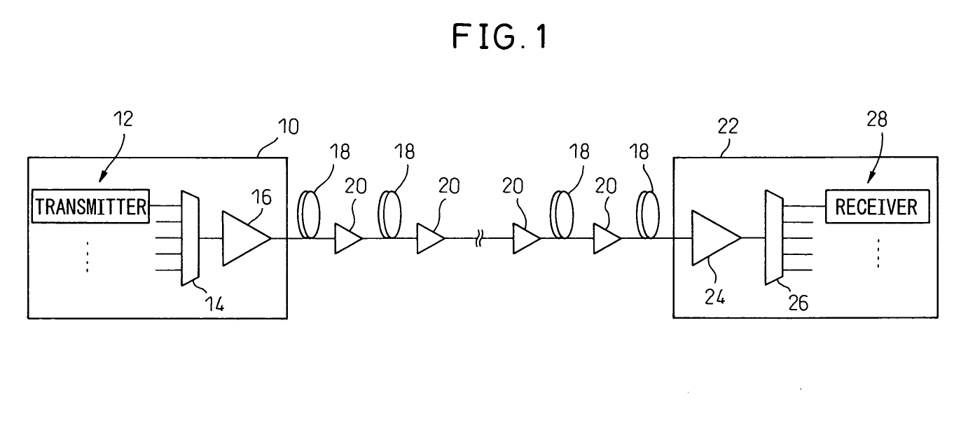

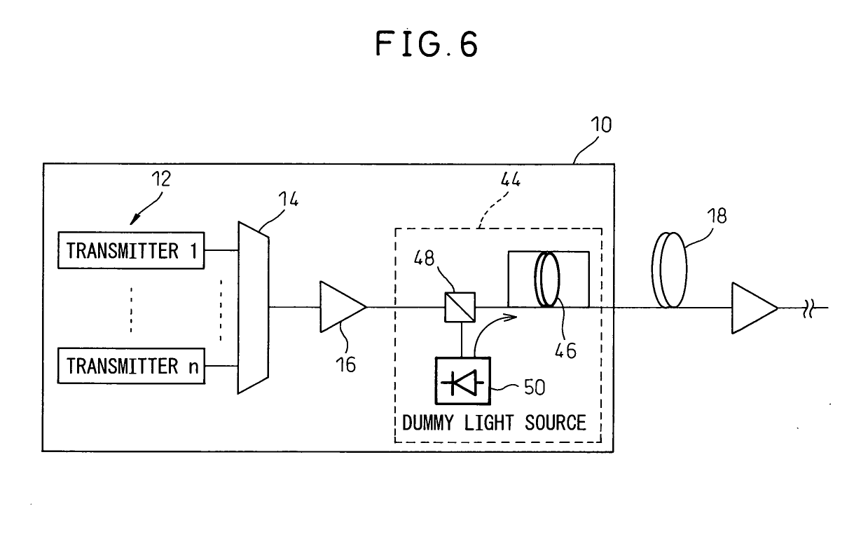

FIG. 6 shows an example, in which an optical transmission device 44 according to one embodiment of the present invention is provided in the transmitting end station 10 in the system of FIG. 1. Signals output from the transmitters 12 are combined by the combiner 14, and the resulting main signal is optically amplified by the optical amplifier 16 and introduced into the highly nonlinear fiber 46 before transmission on the optical fiber transmission line 18. The dummy light from the dummy light source 50 is combined by a combiner 48 with the main signal for introduction into the highly nonlinear fiber 46.

By providing the optical transmission device 44 within the transmitting end station 10, optical power exceeding the rated power can be prevented from being transmitted on the optical fiber transmission line 18 in the event of an instantaneous optical surge.

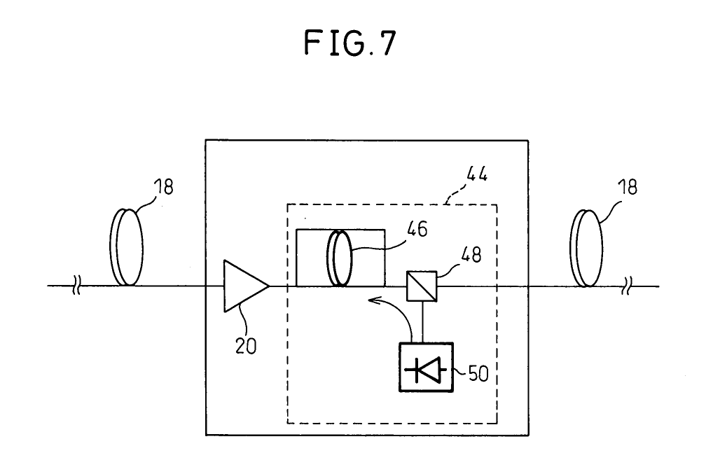

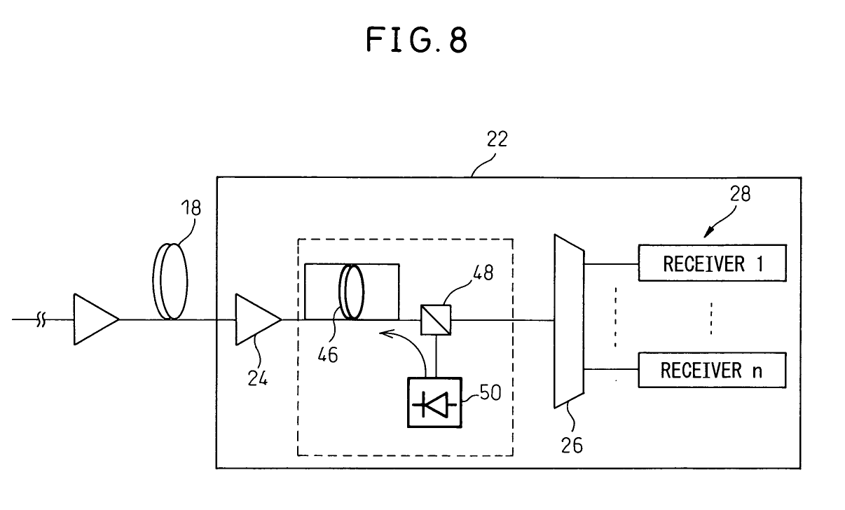

FIGS. 7 and 8 show examples, in which the optical transmission device 44 is provided in the repeater and in the receiving end station, respectively. When the optical transmission device 44 comprising the highly nonlinear fiber 46, the combiner 48, and the dummy light source 50 is provided as shown, optical power exceeding the rated power can be prevented from being transmitted downstream.

Since SRS provides optimum amplification in the wavelength region shifted toward longer wavelengths by about 100 nm to 120 nm from the pump wavelength, light from a light source that operates in the wavelength region shifted toward longer wavelengths by about 100 nm to 120 nm (about 13 THz) from the main signal wavelength region is used as the dummy light. For example, if the main signal wavelength is 1550 nm in the C-band, a U-band light source that emits light in the 1650 nm to 1680 nm region is used as the dummy light source to be combined. Preferably, a light source having a wide spectral linewidth, such as a Fabry-Perot laser, is used as the dummy light source in order to broaden the Raman gain band and reduce the optical surge as much as possible.

The fiber used as the medium for generating SRS is only used to introduce a loss during normal operation when no optical surge occurs. Since minimizing the loss is desirable from the standpoint of reducing the insertion loss, it is preferable to use an optical fiber with an Aeff of 50 μm² or less and reduce the fiber length. By reducing the fiber length, it is possible to construct a smaller fiber module.

If the purpose is to protect the light detectors in the optical receiver, the optical transmission device 44 is provided only in the receiver 22.

If the purpose is to protect the output monitor section of the optical repeater, as well as the optical transmitter, the optical transmission device 44 should be provided in each device.

In the case of a system configuration containing a factor that can cause an optical surge, for example, a configuration that contains an optical switch for path switching, the optical transmission device 44 is provided in such a device to prevent the surge from being transmitted downstream.

In the configuration where the optical transmission device 44 is provided in the optical transmitter or in the optical repeater, the highly nonlinear fiber is used by optimizing the power of the dummy light source and adjusting parameters such as Aeff, loss coefficient, and fiber length, so that by using the SRS, power can be held within the rated input power to the transmission line, thereby preventing excessive optical power from being transmitted downstream.

In the configuration where the optical transmission device 44 is provided in the optical receiver, the highly nonlinear fiber is used by optimizing the power of the dummy light source and adjusting fiber parameters such as Aeff, loss coefficient, and fiber length so that the SRS effect can be produced reliably by taking into consideration the rated input level to the optical receiver (i.e., by inversely calculating from the rated optical power at which the receiver breaks down) thereby preventing excessive optical power from being input to the receiver.

The outputs of the optical amplifiers may differ between the optical transmitter, the optical repeater, and the optical receiver due to their design requirements; in that case, the fiber is used by optimizing the power of the dummy light source and optimally adjusting the parameters for each device.

The highly nonlinear fiber used as the medium for generating SRS is one of the key devices in a system that exploits a nonlinear effect. Fiber parameters can be designed so as to match the purpose of the nonlinear effect used, and the characteristic can be created that matches the purpose. Further, as the highly nonlinear fiber, use may be made of a PCF (Photonic Crystal Fiber) that is fabricated by adjusting its core diameter (effective cross-sectional area: Aeff) so as to exhibit the characteristic (nonlinearity) as designed.

It is also possible to employ a commonly used dispersion-compensating fiber (DCF) as the highly nonlinear fiber. Aeff is about 10 μm² for the standard HNLF, about 10 μm² for the PCF, and about 15 to 30 m² for the DCF.

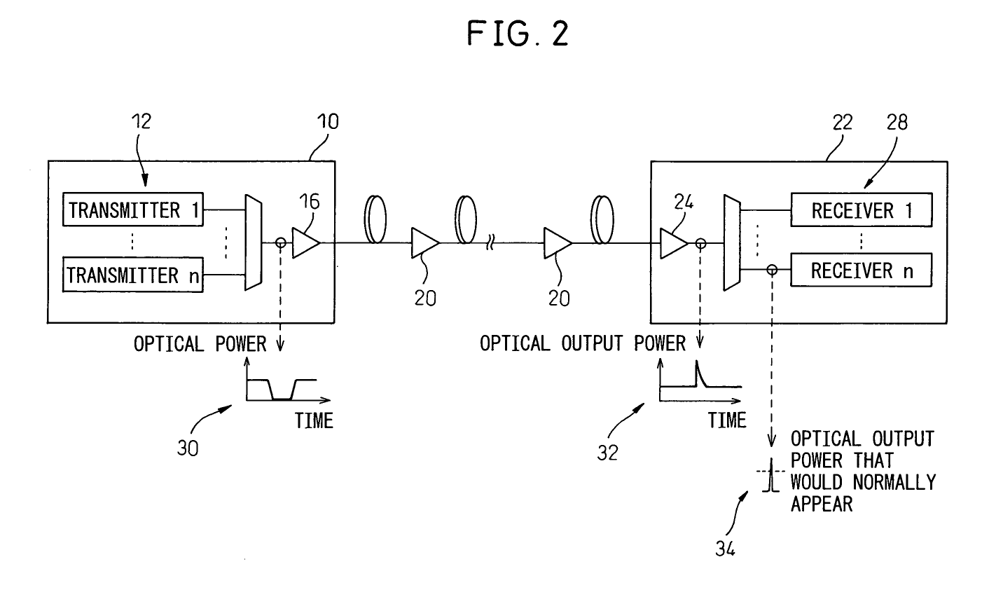

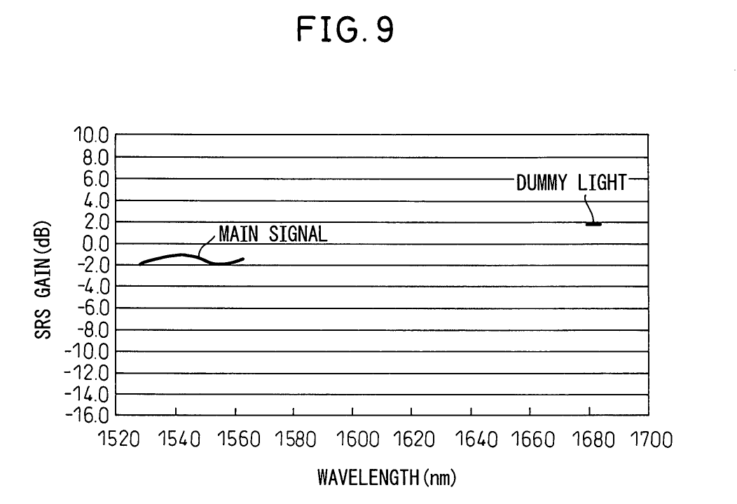

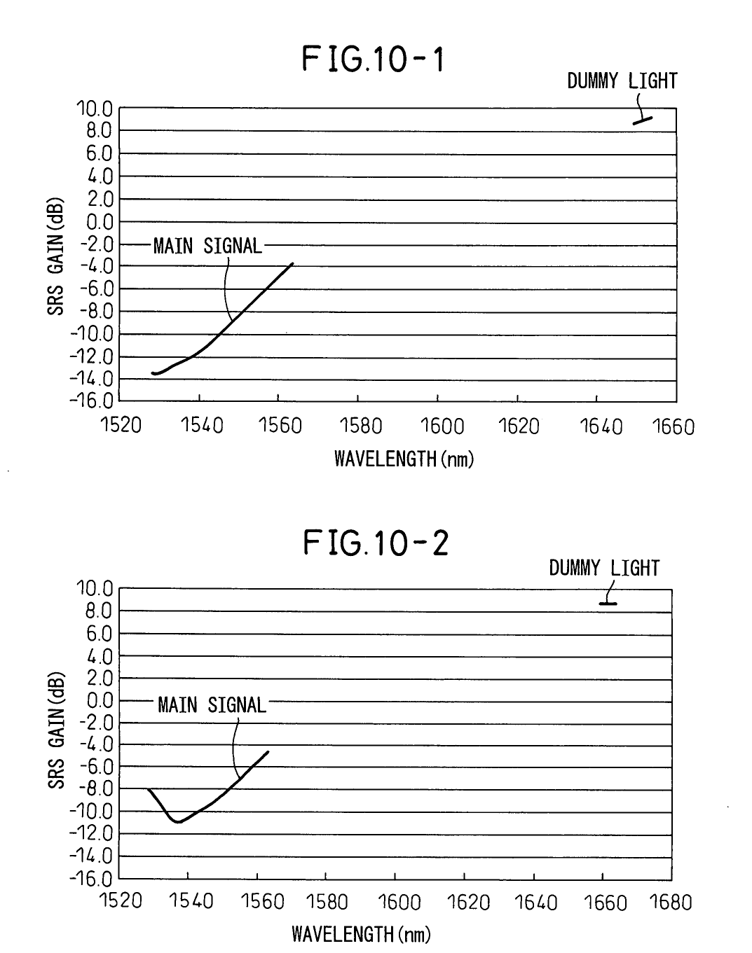

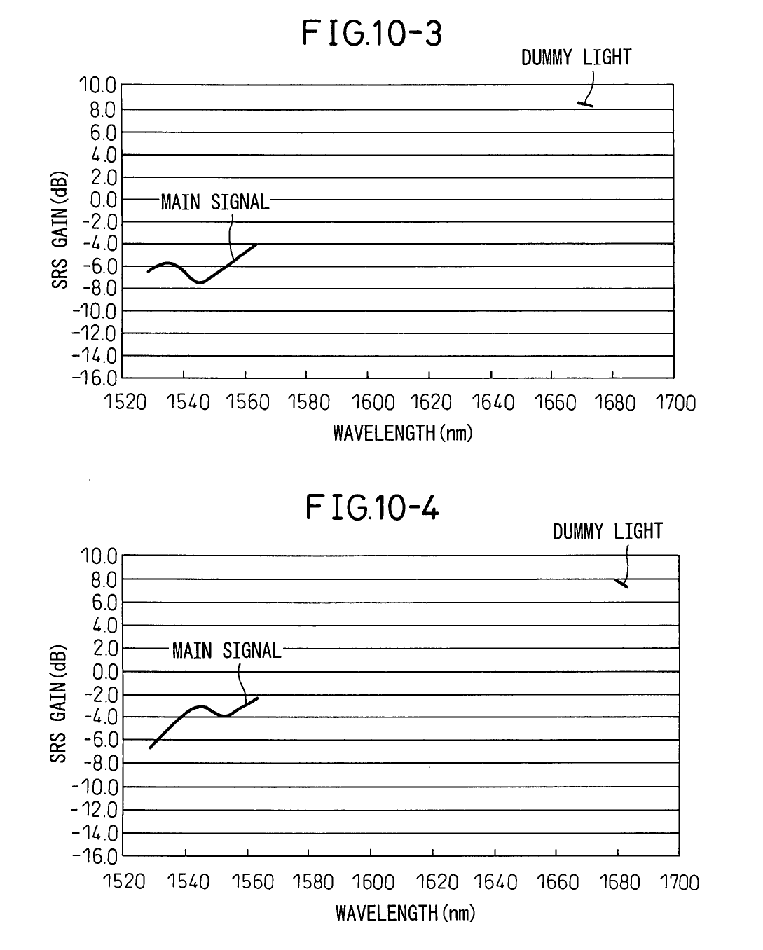

FIGS. 9 and 10-1 to 10-4 show the simulation results of the SRS gain in a highly nonlinear fiber having an Aeff of 10 μm², a loss coefficient of 0.5 dB/km, and a length of 3 km. The system generates 88 wavelengths to carry main signals in the C-band. The gains of the main signal and dummy light are shown in FIG. 9 for a normal case where the power per main signal channel is +3.0 dBm, and in FIGS. 10-1 to 10-4 for a case where the power is +10 dBm assuming an optical surge. The power of the dummy light introduced into the fiber is +20 dBm in either case, and the spectral width is 3.6 nm. Dummy light wavelength, main signal average gain, minimum gain, maximum gain, and differences are shown for the respective cases in the table below.

| | DUMMY LIGHT | | | | |
|---|---|---|---|---|---|
| | WAVELENGTH | AVERAGE | MINIMUM | MAXIMUM | DIFFERENCE |
| | (nm) | GAIN (dB) | GAIN (dB) | GAIN (dB) | (dBp − p) |
| FIG. 9 | 1680-1683.6 | −1.5 | −1.9 | −1.1 | 0.8 |
| FIG. 10-1 | 1650-1653.6 | −9.4 | −13.5 | −3.9 | 9.6 |
| FIG. 10-2 | 1660-1663.6 | −8.6 | −11.0 | −4.7 | 6.3 |
| FIG. 10-3 | 1670-1673.6 | −6.0 | −7.5 | −4.0 | 3.5 |
| FIG. 10-4 | 1680-1683.6 | −4.0 | −6.7 | −2.4 | 4.3 |

When the simulation results of FIG. 9 are compared with the simulation results of FIGS. 10-1 to 10-4, it can be seen that for an optical surge input of +10.0 dBm (FIGS. 10-1 to 10-4) the average gain ranges from −4.0 to −9.4 dB, achieving a sufficient amount of attenuation, compared with the average gain of −1.5 dB for the normal input power of +3.0 dBm (FIG. 9). Further, since the SRS gain varies with the wavelength of the dummy light, the necessary amount of attenuation should be determined from the difference between the expected surge light power and the normal input power or the rated power of the receiver, and the wavelength of the dummy light should be selected accordingly.

The SRS gain can be adjusted by adjusting the parameters for the highly nonlinear fiber or by varying the output power of the dummy light used. Accordingly, by varying the output power of the dummy light for each system having a different optical amplifier output, it becomes possible to address the optical surge more flexibly.

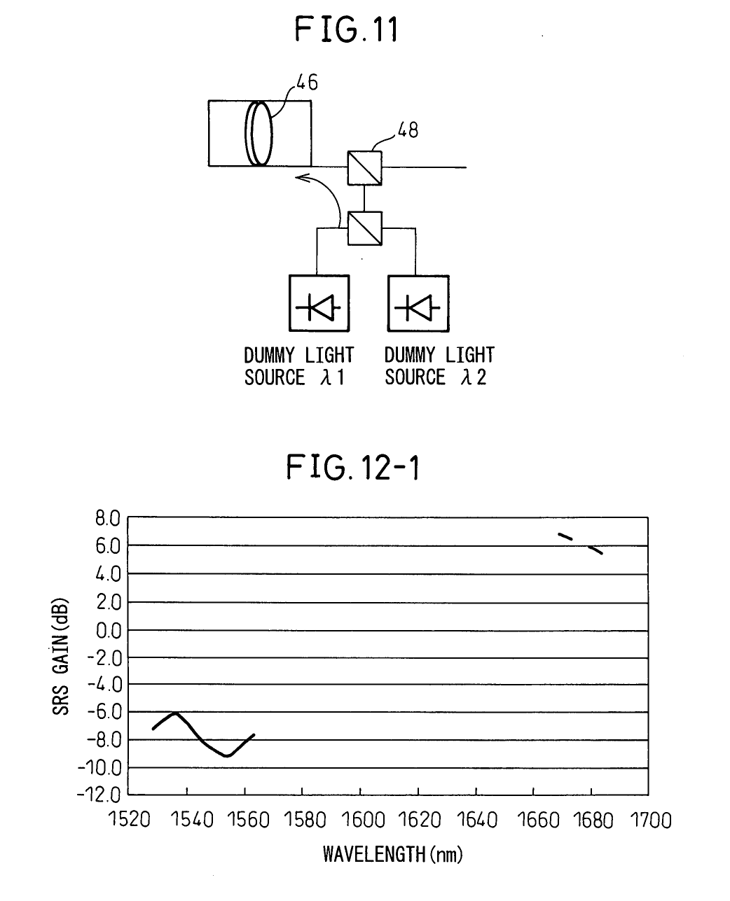

When a plurality of light sources that emit light at respectively different wavelengths in the wavelength range of about 1650 nm to about 1680 nm are used to produce the dummy light of the wavelengths for reducing the surge, the channel characteristics of the SRS gain can be uniformly held below a certain value or inter-channel difference can be reduced in order to reduce the optical surge. FIG. 11 shows a configuration example, and FIGS. 12-1 to 12-3 show simulation results.

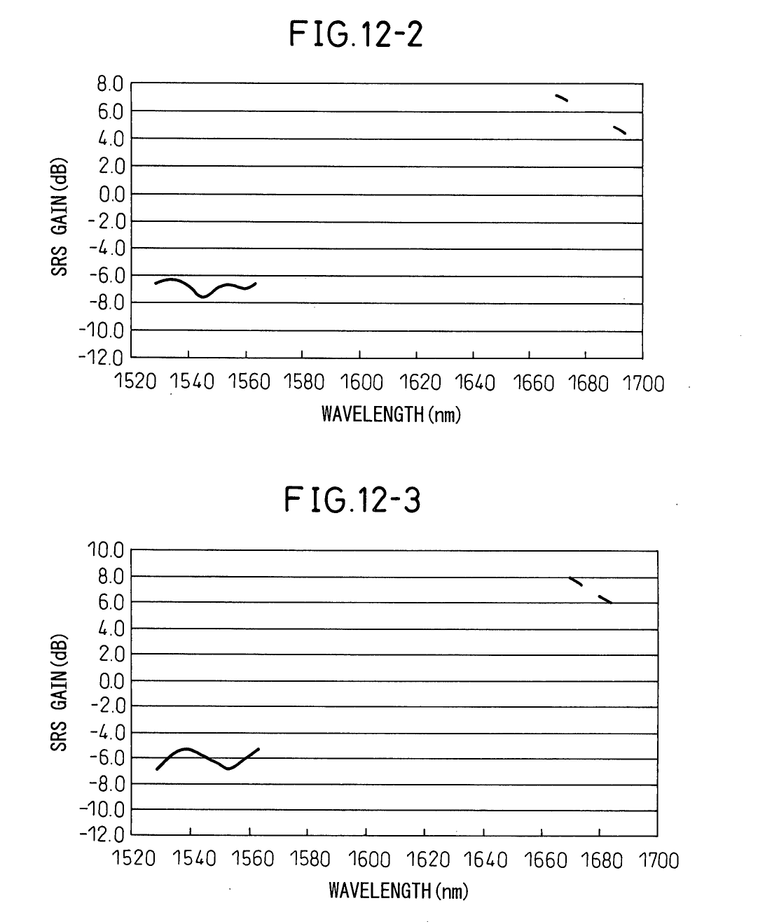

The simulation results of FIG. 12-1 show an SRS gain ≦−6.0 dB for all the main signal channels in the C-band. The results of FIG. 12-2 show an SRS gain ≦−6.0 dB for all the channels and that the inter-channel difference is 1.2 dBp-p. This is effective when it is desired to suppress the inter-channel level difference for each channel receiver. On the contrary, in the case of FIG. 12-3 where the power of the dummy light is different for each wavelength, the results show that the inter-channel difference of the SRS gain is 1.5 dBp-p, that is, the inter-channel difference of the SRS gain can also be reduced by varying the power ratio between the dummy lights of different wavelengths.

The wavelength and power of the dummy light for the respective cases are as shown below.

FIG. 12-1: λ1=1670 to 1673.6 nm (Spectral width: about 4 nm), Power=+20.0 dBm (100 mW)
λ2=1680 to 1683.6 nm (Spectral width: about 4 nm), Power=+20.0 dBm (100 mW)

FIG. 12-2: λ1=1670 to 1673.6 nm (Spectral width: about 4 nm), Power=+20.0 dBm (100 mW)
λ2=1690 to 1693.6 nm (Spectral width: about 4 nm), Power=+20.0 dBm (100 mW)

FIG. 12-3: λ1=1670 to 1673.6, Power=+17.0 dBm
λ2=1680 to 1683.6, Power=+20.0 dBm

If the length of the fiber used as the medium for generating SRS is increased (for example, to 10 km), not only does the insertion loss during the normal operation when no surge occurs increase, but the level drop due to the SRS effect with the dummy light during the normal operation also increases.

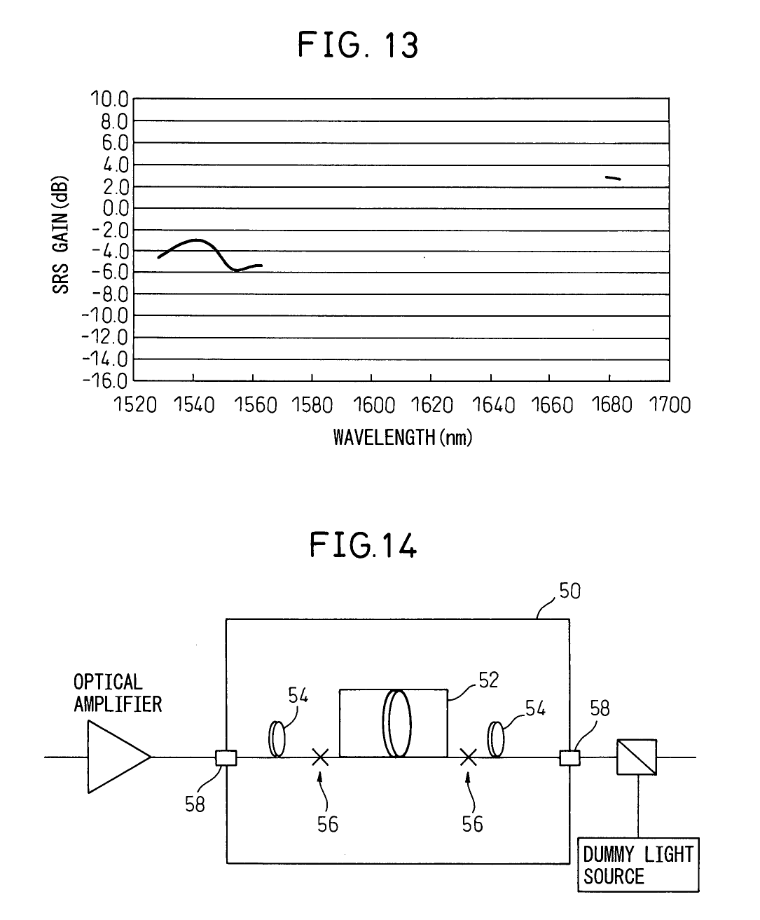

FIG. 13 shows simulation results when the fiber length was extended to 10 km. The average value of the SRS gain was −4.3 dB, which means that the level drops by about 4.3 dB due to the SRS effect with the dummy light during the normal operation when no surge occurs.

Compared with the fiber length of 3 km, the level drop due to SRS becomes larger even in the normal operation, because the effective fiber length having a nonlinear effect becomes longer.

Therefore, it is preferable that the length of the highly nonlinear fiber be made shorter than 10 km, a more preferable length being about 3 km to 5 km.

The smaller the Aeff of the fiber used as the medium for generating SRS, the higher the generation efficiency of SRS, but if a highly nonlinear fiber with an extremely small Aeff is used, a loss due to connection with the standard transmission line (for example, SMF: Aeff of about 80 μm²) may increase. However, a highly nonlinear fiber whose Aeff is 15 μm² or less, for example, about 10 μm², and whose fusion connection loss with SMF is 0.1 dB or less, which is comparable to the conventional fiber, has already been commercially implemented. Therefore, by constructing a fiber module such as shown in FIG. 14, connection loss can be reduced. The fiber module 50 shown in FIG. 14 is constructed by connecting two SMF fiber cords 54 to both ends of the highly nonlinear fiber 52 by means of splices (fusion connections) 56, and can be mounted using connectors 58 in an easily detachable fashion.

When a fiber having a high nonlinearity is used as the medium for generating SRS, a problem may occur in that four wave mixing (FWM) whose optical power threshold for causing a nonlinear effect is generally the lowest may pose a problem during normal operation. Here, the effect of the four wave mixing increases as the main signal wavelength becomes closer to the zero dispersion wavelength, but since the highly nonlinear fiber can be designed by controlling the zero dispersion wavelength, the effect of the four wave mixing (FWM) during the normal operation can be avoided.

If a highly nonlinear fiber whose Aeff is as small as about 10 μm² is used as the medium for generating SRS, there is a possibility that SBS (Stimulated Brillouin Scattering) may occur before the SRS effect distinctly appears.

The threshold Pth of the input power at which SBS occurs is expressed by the following equation.

$$P th = \frac{21 \times A eff}{{g}_{SBS} \times L eff} \times \frac{Δ {V}_{L} + Δ {V}_{B}}{Δ {V}_{B}} \qquad L eff = \frac{1 - exp ( - α L )}{α}$$

Aeff: Effective cross-sectional area of fiber core

gSBS: SBS gain coefficient

Leff: Effective fiber length

ΔVL: Spectral linewidth of signal

ΔVB: SBS gain bandwidth

α: Fiber loss coefficient

L: Fiber length

As can be seen from the above equation, if Aeff is reduced in order to generate SRS efficiently, the generation threshold of SBS also reduces, and when the optical power exceeds the threshold, SBS occurs and the level of the optical power passing through the fiber drops.

However, since the degree to which the optical surge is reduced by the present invention is also dependent on the optical power of the dummy light (for example, about 1650 nm to 1680 nm) to which the gain is provided, the optical surge can be reduced without causing SBS, by increasing the power of the dummy light while allowing the use of an Aeff of 15 m or larger, for example, about 30 μm² which is equivalent to that of a DCF.

FIGS. 15-1 to 15-3 show the results of simulation performed using a fiber having an Aeff equivalent to that of a DCF (about 30 μm²). The wavelength and power of the dummy light are as shown below.

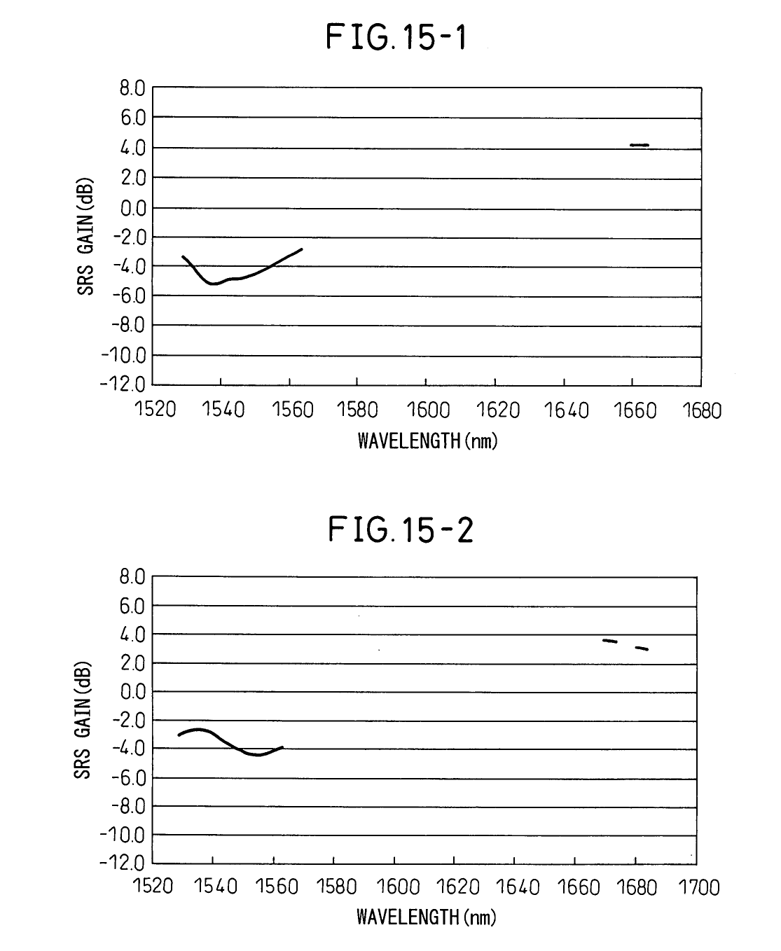

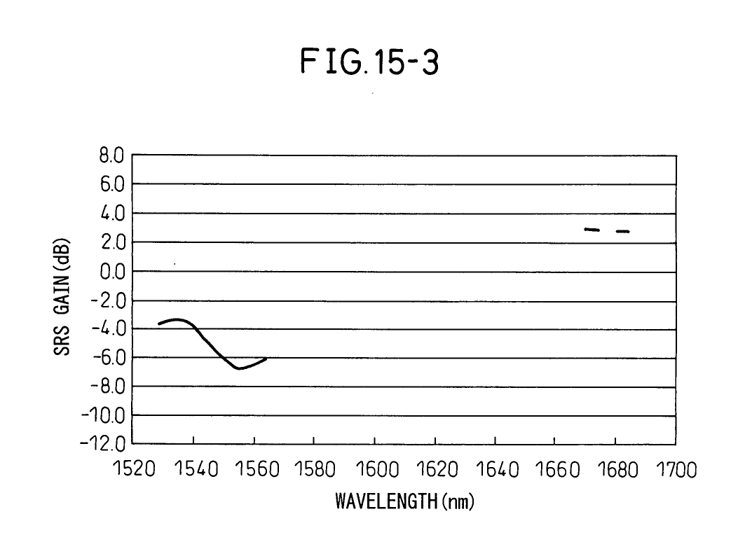

FIG. 15-1: λ1=1660 to 1663.6 nm (Spectral width: about 4 nm), Power=+24.77 dBm (300 mW)

FIG. 15-2: λ1=1670 to 1673.6 nm (Spectral width: about 4 nm), Power=+23.0 dBm (200 mW)
λ2=1680 to 1683.6 nm (Spectral width: about 4 nm), Power=+23.0 dBm (200 mW)

FIG. 15-3: λ1=1670 to 1673.6 nm (Spectral width: about 4 nm), Power=+24.77 dBm (300 mW)
λ2=1680 to 1683.6 nm (Spectral width: about 4 nm), Power=+24.77 dBm (300 mW)

When the Aeff is equivalent to that of a DCF, the optical power threshold at which SBS occurs is about +14.0 dBm/ch for the case of the fiber length of 3 km (calculated with α=0.5 (dB/km), ΔVL=50 MHz, ΔVB=16 MHz, and gSBS=4.1×10⁻¹¹ (mW)).

From the above results, it can be seen that when a fiber having an Aeff equivalent to that of a DCF is used as the medium for generating SRS, any optical surge occurring in the main signal can be reduced by exploiting the SRS effect, even when the optical power is +10.0 dBm/ch at the time of the occurrence of the optical surge. Accordingly, if an optical surge occurs, since the optical surge is reduced by the SRS effect before the optical power reaches the SBS generation threshold, the influence of SBS can be avoided.

1. An optical transmission device comprising:
an optical transmission medium to which signal light of a first wavelength is input; and
a combiner for combining said signal light with dummy light of a second wavelength, wherein
said second wavelength is the wavelength at which the light of said second wavelength is amplified when the light of said first wavelength is input to the optical transmission medium.

2. An optical transmission device according to claim 1, wherein said dummy light has an intensity that suppresses an optical surge generated at said first wavelength.

3. An optical transmission device according to claim 2, wherein said optical transmission medium includes an optical fiber, said amplification is an amplification occurring due to stimulated Raman scattering in said optical fiber, and said optical fiber has an effective cross-sectional area not exceeding 50 μm².

4. An optical transmission device according to claim 3, wherein said optical fiber is a photonic crystal fiber.

5. An optical transmission device according to claim 3, wherein said optical fiber is a dispersion-compensating fiber.

6. An optical transmission device according to claim 2, wherein said dummy light has a wavelength shifted about 100 to 120 nm from an operating signal light band toward longer wavelengths.

7. An optical transmission device according to any one of claims 2 to 5, wherein said dummy light is produced by a plurality of light sources operating at different wavelengths.

8. An optical transmission device according to claim 3, wherein the effective cross-sectional area of said optical fiber is not smaller than 15 μm².
